(19) United States
(12) Patent Application Publication
(10) Pub. No.: US 2026/0195717 A1
(43) Pub. Date: Jul. 9, 2026

(54) INTELLIGENT MEETING SCHEDULING METHOD AND SYSTEM BASED ON SOCIAL MEDIA CONVERSATIONS

(71) Applicant: Charles Lap San CHAN, Taipei (TW)

(72) Inventor: Charles Lap San CHAN, Taipei (TW)

(21) Appl. No.: 19/440,358

(22) Filed: Jan. 5, 2026

(30) Foreign Application Priority Data
Jan. 7, 2025 (TW) 114100580

(51) Int. Cl. G06Q 10/1093; G06F 40/295

(52) U.S. Cl. CPC G06Q 10/1093; G06F 40/295

(57) ABSTRACT

An intelligent meeting scheduling method and system based on social media conversations, for identifying meeting requirements in users'daily conversations and relevant participants and recommending suitable meeting times, includes: receiving and storing text messages including message content from a social software platform; scanning the message content to identify meeting-related terms and extract names and department names, and comparing them with organizational structure data to establish a participant list; accessing electronic calendar data of each participant in the participant list to read scheduled event information within a specified date and time range; calculating common available time slots for each participant within the specified date and time range, calculating suitability scores based on time slot scoring rules, and selecting time slots with the highest scores as suggested options; and receiving selection signals for the suggested options from participants and sending a resource reservation request to a conference room management system.

### CROSS-REFERENCE TO RELATED APPLICATION

This application claims the priority benefit of Taiwan application No. 114100580, filed on Jan. 7, 2025. The entirety of the above-mentioned patent application is hereby incorporated by reference herein and made a part of this specification.

### BACKGROUND OF THE INVENTION

### Field of the Invention

The disclosure relates to a meeting scheduling method and system, and more particularly, to an intelligent meeting scheduling method and system based on social media conversations.

### Description of the Related Art

In modern corporate environments, with digital transformation, remote work and hybrid office models are becoming increasingly popular. In such working environments, internal corporate communication and collaboration rely increasingly on various social software platforms, such as Microsoft Teams, FACEBOOK, LINE, and the like. These platforms not only serve as instant messaging tools but have also become the core hub for team collaboration.

However, when discussions need to be translated into actual actions, particularly in terms of scheduling meetings, users often need to switch between different systems. This not only reduces work efficiency but is also prone to causing communication gaps.

Traditional meeting scheduling methods typically require the meeting initiator to manually execute multiple steps: confirming participants, checking everyone's calendar, finding a common available time, and booking a conference room. This process is not only time-consuming but also susceptible to errors. For example, important attendees might be omitted, or the time preferences of certain participants might not be taken into account. Furthermore, in cross-departmental or cross-time zone meeting arrangements, the complexity of such manual coordination further increases, often requiring multiple rounds of communication to finalize the meeting time.

Existing meeting scheduling tools, although providing automated functions, mostly require users to explicitly initiate the scheduling process, such as by filling out specific forms or clicking specific buttons. This approach does not align with the natural conversation habits of users in social software, thereby increasing the barrier to entry. Moreover, these tools typically focus only on time coordination functions, lacking the capability for subsequent conference room arrangements, and are unable to effectively track the execution status of meeting resolutions.

Another significant issue is that existing meeting management systems generally lack the ability to learn and optimize; they cannot learn from past meeting data. This results in the system's inability to provide truly intelligent suggestions and prevents the continuous improvement of service quality throughout the usage process.

Therefore, developing a solution that can overcome the aforementioned drawbacks, automatically identify meeting requirements, and intelligently schedule meetings is of great necessity and significance.

### SUMMARY OF THE INVENTION

An objective of the disclosure is to provide an intelligent meeting scheduling method and system capable of automatically identifying meeting requirements based on the content of social media conversations.

Another objective of the disclosure is to provide an intelligent meeting scheduling method and system that can recommend suitable meeting times and assist in booking conference rooms.

To achieve the above objectives, the disclosure provides an intelligent meeting scheduling system based on social media conversations, comprising:
a dialogue recording module, configured to receive and store text messages from a social software platform, wherein the text message includes a timestamp, a sender identifier, and message content;
an analysis processing module, configured to scan the message content, identify meeting-related terms pre-stored in a system database, extract names and department names, and compare them with organizational structure data stored in the system database to establish a participant list;
a query module, configured to access electronic calendar data of each participant in the participant list and read scheduled event information within a specified date and time range;
a suggestion generation module, configured to calculate common available time slots for each participant within the specified date and time range, calculate a suitability score for each available time slot based on a time slot scoring rule, and select a plurality of time slots with the highest suitability scores as suggested options; and
a meeting arrangement module, configured to receive selection signals for the suggested options from each participant via a graphical user interface and send a resource reservation request to a conference room management system.
   The disclosure provides an intelligent meeting scheduling method based on social media conversations, comprising the following steps:
Step (A) receiving and storing text messages from a social software platform, wherein the text message includes a timestamp, a sender identifier, and message content;
Step (B) scanning the message content, identifying meeting-related terms pre-stored in a system database, extracting names and department names, and comparing them with organizational structure data stored in the system database to establish a participant list;
Step (C) accessing electronic calendar data of each participant in the participant list and reading scheduled event information within a specified date and time range;
Step (D) calculating common available time slots for each participant within the specified date and time range, calculating a suitability score for each available time slot based on a time slot scoring rule, and selecting a plurality of time slots with the highest suitability scores as suggested options; and
Step (E) receiving selection signals for the suggested options from each participant via a graphical user interface and sending a resource reservation request to a conference room management system.

### BRIEF DESCRIPTION OF THE DRAWINGS

FIG. 1 is a schematic diagram of a system architecture of an

intelligent meeting scheduling system based on social media conversations according to a preferred embodiment of the disclosure;

FIG. 2 is a flowchart of an intelligent meeting scheduling method based on social media conversations according to a first preferred embodiment of the disclosure; and

FIG. 3 is a flowchart of an intelligent meeting scheduling method based on social media conversations according to a second preferred embodiment of the disclosure.

### DETAILED DESCRIPTION OF THE INVENTION

To make the description of the present disclosure more detailed and complete, the following provides illustrative descriptions of the implementation aspects and specific embodiments of the present case; however, this is not the only form for implementing or applying the specific embodiments of the disclosure. The detailed description covers features of multiple specific embodiments as well as the method steps and their sequence for constructing and operating these specific embodiments. However, other specific embodiments may also be utilized to achieve the same or equivalent functions and step sequences.

The disclosure proposes an intelligent meeting scheduling method and system based on social software conversations, which can automatically identify meeting requirements within users'daily conversations, intelligently identify relevant participants, and recommend suitable meeting times.

The intelligent meeting scheduling method and system of the disclosure can further arrange conference rooms and learn from past meeting data to provide truly intelligent suggestions and enhance its service quality.

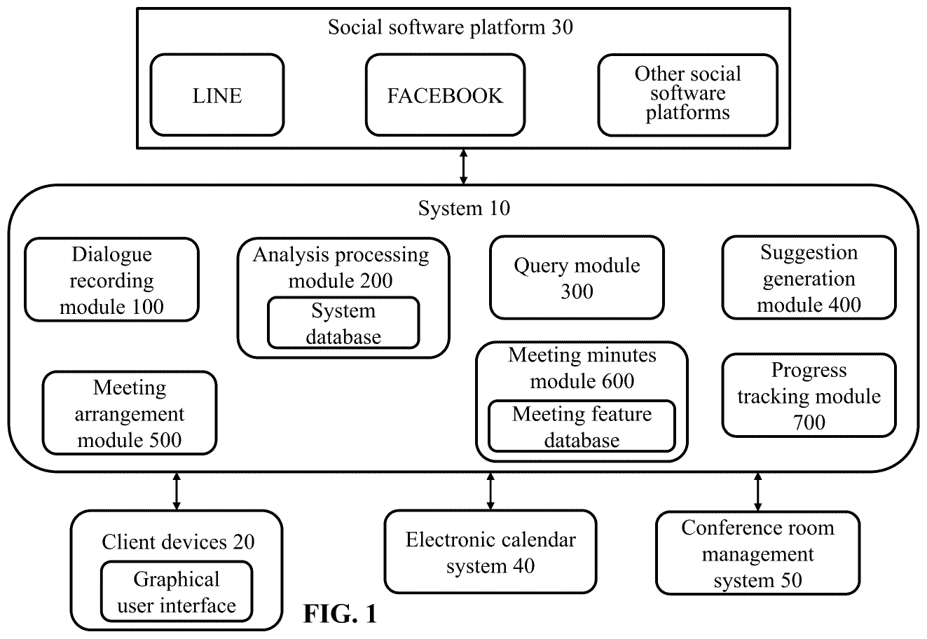

Referring to FIG. 1, a schematic diagram of a system architecture of an intelligent meeting scheduling system according to a preferred embodiment of the disclosure is shown.

The following will first explain the purpose of each module in the system, and the operation process of the system will be further described later.

In FIG. 1, the system 10 comprises a dialogue recording module 100, an analysis processing module 200, a query module 300, a suggestion generation module 400, and a meeting arrangement module 500. The system 10 may optionally further comprise a meeting minutes module 600 and a progress tracking module 700. The system 10 may be electrically connected via a network to client devices 20, a social software platform 30, an electronic calendar system 40, and a conference room management system 50.

The social software platform 30 may be enterprise internal communication software or an instant messaging application, such as Microsoft Teams, FACEBOOK, LINE, or other social software. Users can access the social software platform 30 through various client devices 20, such as personal computers, laptops, smartphones, etc., and engage in text conversations on the platform that may mention the desire to convene a meeting.

The dialogue recording module 100 is configured to receive and store text messages from the social software platform 30. Each text message includes a transmission timestamp, a sender identifier, and message content; this information will be recorded and used for subsequent analysis.

The analysis processing module 200 is configured to scan the message content, identify meeting-related terms pre-stored in a system database within the analysis processing module 200, and extract information such as names and department names from the message.

The system database also stores organizational structure data, and the analysis processing module 200 compares the extracted information with the organizational structure data to establish a participant list for the meeting.

The query module 300 is configured to access the electronic calendar data of each member in the participant list within the electronic calendar system 40 and read scheduled event information within a specified date and time range. The electronic calendar data in the electronic calendar system 40 includes time information such as meetings and itineraries already scheduled by the user.

The suggestion generation module 400 is configured to calculate common available time slots for each participant within the specified date and time range. The suggestion generation module 400 calculates a suitability score for each available time slot based on a time slot scoring rule and selects a plurality of time slots with the highest suitability scores as suggested options.

The time slot scoring rule considers various factors to evaluate the suitability of the time slots. The suggested options generated by the suggestion generation module 400 can be displayed on a graphical user interface of the client devices 20 of each participant.

The meeting arrangement module 500 is configured to receive the participants'selection of the suggested options. As mentioned above, participants can view and select preferred time slots via the graphical user interface on their client devices 20, and the meeting arrangement module 500 then sends a resource reservation request to the conference room management system 50 based on the selection results.

The system 10 of the disclosure may further include a meeting minutes module 600, configured to establish and maintain a meeting feature database. The meeting feature database records meeting content, duration statistics categorized by meeting type, participation rate statistics, and on-time completion rate statistics for meetings in various time slots; this information can be used to optimize the generation of suggested options.

In addition, the progress tracking module 700 of the disclosure uses a natural language processing model to identify progress tracking milestones and person-in-charge information from the meeting content records, and establishes corresponding check events in the electronic calendar system 40 of the relevant meeting participants.

The module may also generate progress analysis reports, providing information such as overall completion status, key progress items, and analysis of delay causes.

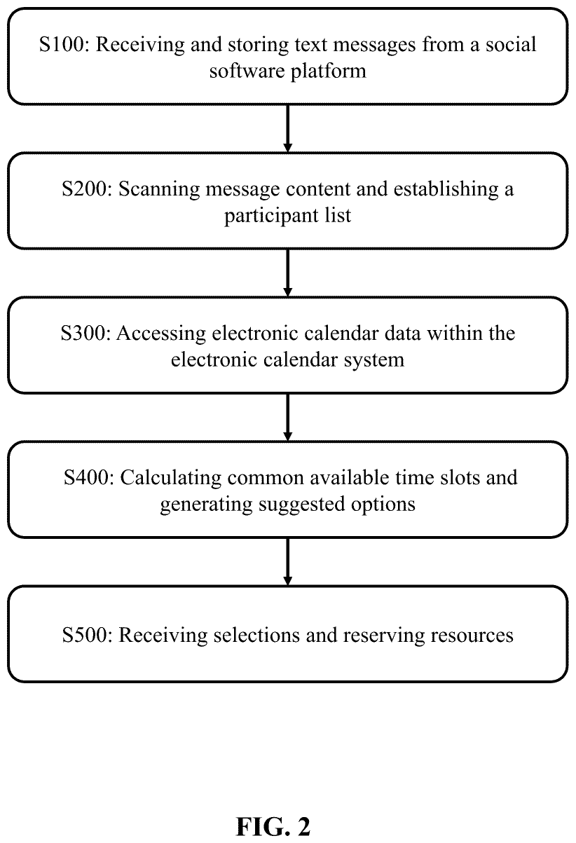

Please refer to FIG. 2, which shows a flowchart of an intelligent meeting scheduling method based on social software conversations according to a first preferred embodiment of the disclosure.

The method executes the following steps via various functional modules. The implementation methods, possible variations, and operational processes of each step are described in detail below with examples.

Step S100: Receiving and storing text messages from a social software platform.

In this step, the dialogue recording module 100 continuously records text messages from the social software platform 30 via API interfacing, such as text messages from Microsoft Teams, FACEBOOK, LINE, or other social software.

The transmission timestamp included in the text message is recorded in a unified time format (such as UTC), the sender identifier can be a platform-native user ID or an identifier corresponding to an enterprise employee number, and the message content includes plain text, emoticons, or formatted text.

This step may be implemented via the following ways:
API interfacing: establishing an API connection with the social software platform 30;
WebSocket connection: establishing real-time two-way communication;
Periodic polling: checking for new messages at regular intervals.

For example, the dialogue recording module 100 receives a message in the following form: [2024 Jan. 15 4:30:25] [ID: EM 001] “We need to discuss the Q1 project progress next week, please have the PM and colleagues from the development team attend.”

Step S200: Scanning message content and establishing a participant list. In this step, the analysis processing module 200 executes message analysis, which may, for example, use natural language processing technology to scan the message content, identify meeting-related terms pre-defined in the system database of the analysis processing module 200 (such as “discuss”, “meeting”, “report”, etc.), and simultaneously extract information such as names and department names appearing in the text.

The analysis processing module 200 compares the extracted information with the organizational structure data stored in the analysis processing module 200 to confirm the identities of the relevant personnel and establish a participant list.

This step may adopt various implementation manners, including:
Rule-based text matching;
Named Entity Recognition (NER) using machine learning models;
Dynamic comparison with an organizational structure database.

Continuing the previous example, the analysis processing module 200 identifies:
Meeting-related term: “discuss”
Department names: “PM”, “development team”
Meeting subject: “Q1 project progress” and establishes a participant list: [Project Manager, Development Department Head, Development Team Members].

Step S300: Accessing electronic calendar data within the electronic calendar system 40. The query module 300 accesses the electronic calendar system 40 of each member in the participant list via a calendar API to read scheduled event information within a specific time range. This step can support various electronic calendar systems (such as Google Calendar, Outlook, etc.) and can simultaneously process calendar data from different time zones.

This step may be implemented via:
Calendar API access: reading various types of electronic calendar systems 40;
Data synchronization: periodically updating electronic calendar data.
   In this example, the query module 300 reads:
Time range: 2024 Jan. 22 to 2024 Jan. 26
Scheduled meetings and events for each participant.

Step S400: Calculating common available time slots and generating suggested options. In this step, the suggestion generation module 400 performs time slot analysis, which may first identify common free time for all participants, then calculate a suitability score for each available time slot based on time slot scoring rules, and select a plurality of time slots with the highest suitability scores as suggested options.

The suggested options generated by the suggestion generation module 400 can be displayed on a graphical user interface of the client devices 20 of each participant.

In an embodiment of the disclosure, the suggestion generation module 400 may consider multiple scoring factors, including: Whether it is within general working hours (e.g., 9:00-18:00); Whether it is adjacent to other meetings; Whether it is a meeting time slot habitually used by the participants.

This step may employ:
Time interval calculation: finding common free slots;
Multi-factor scoring: considering time slot suitability;
Ranking algorithm: selecting the best options.

According to the analysis results of the above example, the suggestion generation module 400 produces:
Suggested Time Slot 1: 2024 Jan. 23 14:00-15:00 (Suitability Score: 0.92)
Suggested Time Slot 2: 2024 Jan. 24 10:00-11:00 (Suitability Score: 0.88)
Suggested Time Slot 3: 2024 Jan. 25 15:30-16:30 (Suitability Score: 0.85).

Step S500: Receiving selections and reserving resources. The meeting arrangement module 500 executes option confirmation and resource reservation, and participants can view and select preferred time slots via the graphical user interface on their client devices 20. Upon receiving sufficient selection signals, the meeting arrangement module 500 sends a resource reservation request to the conference room management system 50.

This step may support various interactive selection methods, including:
Via the built-in voting function of the social software platform 30;
Via links in emails for selection;
Via a dedicated meeting scheduling interface for selection.

Continuing the previous example, the meeting arrangement module 500 receives that the majority of participants selected the time slot 2024 Jan. 23 14:00-15:00, and immediately reserves a conference room with the conference room management system 50 and sends meeting invitations.

From the above description, it can be understood that the disclosure receives text messages from the social software platform 30 via the dialogue recording module 100, enabling automatic identification of meeting-related discussions and real-time processing; utilizes the natural language processing technology of the analysis processing module 200 to scan message content, accurately identifying meeting-related terms, names, and department names, and compares them with organizational structure data to establish a participant list, significantly reducing manual organization work.

The system automatically accesses participants'electronic calendar data via the query module 300, calculates common available time slots via the suggestion generation module 400, and considers multiple factors such as general working hours and the reasonableness of meeting sequences to calculate a suitability score for each time slot, selects a plurality of time slots with the highest suitability scores as suggested options, and displays them on the graphical user interface of each participant's client device 20 for selection.

The meeting arrangement module 500 receives the participants'selection of the suggested options and sends a reservation request to the conference room management system 50 based on the selection results. Thereby, the meeting scheduling process can be effectively simplified, improving efficiency and reducing manual operation costs.

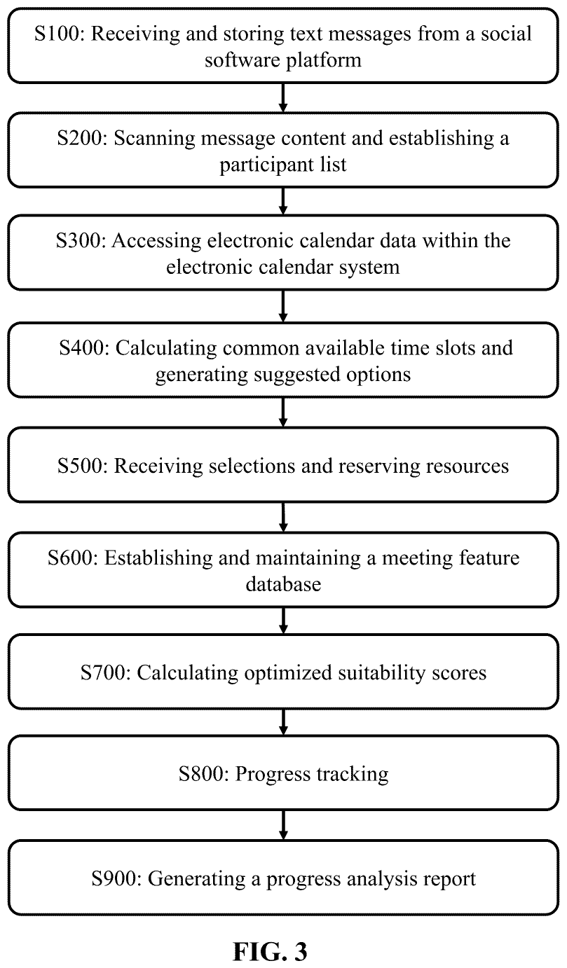

Please refer to FIG. 3, which shows a flowchart of an intelligent meeting scheduling method based on social software conversations according to a second preferred embodiment of the disclosure.

FIG. 3, in addition to including the aforementioned steps S100-S500, also includes the following steps, which will be described as follows:

Step S600: Establishing and maintaining a meeting feature database.

The meeting minutes module 600 establishes and maintains the meeting feature database. The meeting minutes module 600 may, for example, continuously convert the speech content of meeting participants into text by connecting to a real-time speech-to-text function of a conference system in the conference room, and use natural language processing technology for keyword identification and topic classification.

The meeting minutes module 600 may instantly tag important resolutions, milestones, and person-in-charge information, while recording meeting-related statistics such as meeting duration, participation rate, etc., and finally organize them into structured meeting minutes stored in the meeting feature database.

In an embodiment of the disclosure, the recorded meeting-related information may comprise the following:
Meeting content records: meeting discussion points, resolutions;
Meeting duration statistics: actual time consumed by different types of meetings;
Participation rate statistics: attendance numbers, late arrivals and early departures;
On-time completion ratio: statistics on end times of meetings in various time slots.

For example, the meeting minutes module 600 records this Q1 Project Progress Meeting in the meeting feature database: [Meeting Content Record]: Q1 Project Progress Meeting (MTG-20240123-001) held in Conference Room 3 from 14:00 to 14:55 on Jan. 23, 2024, hosted by Project Manager Li, attended by Development Supervisor Wang, UI Designer Xiaoming Wang, and Engineer Zhang; Engineer Liu was on leave. The report indicated the overall project completion is 75%, with backend API development at 90%, frontend interface development at 60%, and UI design at 45%. The final resolution was that UI design, led by Xiaoming Wang, must be completed by next Friday (2024 Jan. 26) with support from the frontend team, and progress tracking is set for next Tuesday. [Type]: Project Progress Meeting [Duration]: 55 minutes [Participation Rate]: 95% [Ended On Time]: Yes.

Step S700: Calculating optimized suitability scores. When it is detected that a meeting feature database already exists, the suggestion generation module 400 may refer to the statistical data in the meeting feature database to recalculate an optimized suitability score for each available time slot.

For example: if referring to the statistical data in the meeting feature database shows a higher completion rate for project meetings in the morning, the adjusted suggested time slots may prioritize morning slots and assign higher scores, and the length of the suggested time slots can be adjusted based on historical meeting duration data.

For example, updating the suggested options as: 2024 Jan. 24 10:00-11:00 (Optimization Score 0.95) 2024 Jan. 23 14:00-15:00 (Optimization Score 0.90).

Step S800: Progress tracking. The progress tracking module 700 uses a natural language processing model to identify progress tracking milestones and person-in-charge information from the meeting content records, and establishes corresponding check events in the electronic calendar system 40.

For example, the progress tracking module 700 identifies from the meeting minutes: “UI design needs to be completed by next Friday (2024 Jan. 26), Person in Charge: Xiaoming Wang”.

The progress tracking module 700 may create reminder events in the electronic calendar system 40 of the relevant personnel; for example, it may create a reminder event in the electronic calendar system 40 of the person in charge, Xiaoming Wang.

Step S900: Generating a progress analysis report. The progress tracking module 700 generates a progress analysis report based on the meeting content records. The content of the progress analysis report may include, for example, one or a combination of overall completion status, key progress items, and analysis of delay causes, but the disclosure is not limited thereto.

In an embodiment of the disclosure, the progress analysis report can be automatically distributed by the progress tracking module 700 according to permission settings. For example: project-related supervisors (such as project managers, department heads) receive full reports, including overall completion status, key progress items, and analysis of delay causes; project members receive progress information relevant to their responsible items.

In an embodiment of the disclosure, the content of the progress analysis report may be displayed as follows: Overall Project Completion: 75% Key Progress Item: UI Design Completion Deadline Analysis of Delay Causes: Insufficient human resource allocation and frequent requirement changes.

From the above description, it can be understood that in another embodiment of the disclosure, a meeting feature database can be further established via the meeting minutes module 600 to record statistical data such as meeting duration and participation rate, enabling the suggestion generation module 400 to optimize time slot scoring accordingly and provide better suggested options to meeting participants. Then, the progress tracking module 700 can also automatically identify milestones and person-in-charge information in the meeting minutes, establish tracking events, and generate progress analysis reports, realizing full-process automation from meeting scheduling to progress tracking, and significantly improving work efficiency and project management effectiveness.

While various examples of the disclosed technology have been described above, it should be understood that these examples have been presented by way of example only, and not limitation. Likewise, the various diagrams may depict example architectures or other configurations for the disclosed technology, which are provided to aid in understanding the features and functionality that can be included in the disclosed technology. The disclosed technology is not limited to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein.

Additionally, with regard to flowcharts, operational descriptions, and method claims, the order in which the steps are presented herein should not require that the disclosed technology be implemented to perform the recited functionality in the same order, unless the context dictates otherwise.

The foregoing description is merely of the preferred embodiments of the disclosure and is not intended to limit the scope of implementation of the disclosure. Accordingly, all equivalent changes and modifications made in accordance with the shape, structure, features, and spirit described in the claims of the disclosure should be included within the scope of the claims of the disclosure.

What is claimed is:

1. An intelligent meeting scheduling system based on social media conversations, comprising:
a dialogue recording module, configured to receive and store text messages from a social software platform, wherein the text message comprises a transmission timestamp, a sender identifier, and message content;
an analysis processing module, configured to scan the message content, identify meeting-related terms pre-stored in a system database, extract names and department names, and compare them with organizational structure data stored in the system database to establish a participant list;
a query module, configured to access electronic calendar data of each participant in the participant list and read scheduled event information within a specified date and time range;
a suggestion generation module, configured to calculate common available time slots for each participant within the specified date and time range, calculate a suitability score for each available time slot based on a time slot scoring rule, and select a plurality of time slots with the highest suitability scores as suggested options; and
a meeting arrangement module, configured to receive selection signals for the suggested options from each participant via a graphical user interface and send a resource reservation request to a conference room management system.

2. The intelligent meeting scheduling system as claimed in claim 1, further comprising a meeting minutes module configured to establish and maintain a meeting feature database, wherein the content of the meeting feature database comprises one or a combination of: meeting content records, meeting duration statistics categorized by meeting type, participation rate statistics, and on-time completion rate statistics for meetings in various time slots.

3. The intelligent meeting scheduling system as claimed in claim 1, wherein the suggestion generation module further comprises referring to statistical data in the meeting feature database to recalculate an optimized suitability score for each available time slot, and selecting a plurality of time slots with the highest optimized suitability scores as optimized suggested options.

4. The intelligent meeting scheduling system as claimed in claim 2, further comprising a progress tracking module using a natural language processing model to identify a progress tracking milestone and person-in-charge information from the meeting content records, and establishing a corresponding check event in the electronic calendar data.

5. The intelligent meeting scheduling system as claimed in claim 4, wherein the progress tracking module further comprises generating a progress analysis report, and the content of the progress analysis report may comprise one or a combination of: overall completion status, key progress items, and analysis of delay causes.

6. An intelligent meeting scheduling method based on social media conversations, comprising the following steps:
Step (A) receiving and storing text messages from a social software platform, wherein the text message comprises a transmission timestamp, a sender identifier, and message content;
Step (B) scanning the message content, identifying meeting-related terms pre-stored in a system database, extracting names and department names, and comparing them with organizational structure data stored in the system database to establish a participant list;
Step (C) accessing electronic calendar data of each participant in the participant list and reading scheduled event information within a specified date and time range;
Step (D) calculating common available time slots for each participant within the specified date and time range, calculating a suitability score for each available time slot based on a time slot scoring rule, and selecting a plurality of time slots with the highest suitability scores as suggested options; and
Step (E) receiving selection signals for the suggested options from each participant via a graphical user interface and sending a resource reservation request to a conference room management system.

7. The intelligent meeting scheduling method as claimed in claim 6, further comprising: establishing and maintaining a meeting feature database, wherein the content of the meeting feature database comprises one or a combination of: meeting content records, meeting duration statistics categorized by meeting type, participation rate statistics, and on-time completion rate statistics for meetings in various time slots.

8. The intelligent meeting scheduling method as claimed in claim 6, further comprising: referring to statistical data in the meeting feature database to recalculate an optimized suitability score for each available time slot, and selecting a plurality of time slots with the highest optimized suitability scores as optimized suggested options.

9. The intelligent meeting scheduling method as claimed in claim 7, further comprising: using a natural language processing model to identify a progress tracking milestone and person-in-charge information from the meeting content records, and establishing a corresponding check event in the electronic calendar data.

10. The intelligent meeting scheduling method as claimed in claim 9, further comprising: generating a progress analysis report, wherein the content of the progress analysis report comprises one or a combination of: overall completion status, key progress items, and analysis of delay causes.
